(19) United States
(12) Patent Application Publication
(10) Pub. No.: US 2022/0237455 A1
(43) Pub. Date: Jul. 28, 2022

(54) NEURAL-NETWORK QUANTIZATION METHOD AND APPARATUS

(71) Applicant: DENSO CORPORATION, Kariya-city (JP)

(72) Inventor: Masafumi MORI, Kariya-city (JP)

(21) Appl. No.: 17/648,933

(22) Filed: Jan. 25, 2022

(30) Foreign Application Priority Data
Jan. 26, 2021 (JP) 2021-009978

(51) Int. Cl. G06N 3/08

(52) U.S. Cl. CPC G06N 3/08

(57) ABSTRACT

A neural-network quantization method includes retrieving, from a reference layer, statistical information on layer parameters related to the reference layer. The layer parameters include features of the reference layer. The neural-network quantization method includes determining, based on the statistical information, a quantization range for the layer parameters related to a quantization target layer. The neural-network quantization method quantizes selected layer parameters in the layer parameters related to the quantization target layer. The selected layer parameters are within the quantization range.

### CROSS REFERENCE TO RELATED APPLICATIONS

This application is based on and claims the benefit of priority from Japanese Patent Application 2021-009978 filed on Jan. 26, 2021, the disclosure of which is incorporated in its entirety herein by reference.

### TECHNICAL FIELD

The present disclosure relates to methods and apparatuses for quantizing parameters used in a neural network.

### BACKGROUND

Typical quantization for neural networks quantizes parameters, each of which has a high bitwidth (bit-width), used in an artificial neural network to converted parameters, each of which has a lower bitwidth.

### SUMMARY

An exemplary aspect of the present disclosure is a method of quantizing a neural network that includes sequential layers; the sequential layers include a quantization target layer and a reference layer other than the quantization target layer. The method includes

1. Retrieving, from the reference layer, statistical information on layer parameters related to the reference layer, the layer parameters including the features of the reference layer

2. Determining, based on the statistical information, a quantization range for the layer parameters related to the quantization target layer

3. Quantizing selected layer parameters in the layer parameters related to the quantization target layer, the selected layer parameters being within the quantization range

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the structure of a neural network apparatus according to the first embodiment of the present disclosure;

FIG. 2 is a flowchart schematically illustrating an example of the procedure of a CNN quantization method carried out by a processor of a quantization apparatus illustrated in FIG. 1;

FIGS. 3(a) to 3(c) are a joint graph diagram schematically illustrating how the CNN quantization method is carried out;

FIG. 4 is a block diagram schematically illustrating an example of the structure of a neural network apparatus according to the second embodiment of the present disclosure;

FIG. 5 is a flowchart schematically illustrating an example of the procedure of a CNN quantization method carried out by a processor of a quantization apparatus illustrated in FIG. 4;

FIGS. 6(a) to 6(d) are a joint graph diagram schematically illustrating how the CNN quantization method is carried out;

FIG. 7 is a block diagram schematically illustrating an example of the structure of a neural network apparatus according to the third embodiment of the present disclosure;

FIG. 8 is a flowchart schematically illustrating an example of the procedure of a CNN quantization method carried out by a processor of a quantization apparatus illustrated in FIG. 4;

FIGS. 9(a) to 9(c) are a joint graph diagram schematically illustrating how the CNN quantization method is carried out;

FIG. 10 is a block diagram schematically illustrating an example of the structure of a neural network apparatus according to the fourth embodiment of the present disclosure; and

FIG. 11 is a flowchart schematically illustrating an example of the procedure of a CNN quantization method carried out by a processor of a quantization apparatus illustrated in FIG. 10.

### DETAILED DESCRIPTION OF EMBODIMENT

Such typical quantization for neural networks, for example disclosed in Japanese Patent Application Publication No. 2019-32833, quantizes parameters, each of which has a high bitwidth (bit-width), used in an artificial neural network to converted parameters, each of which has a lower bitwidth. This results in a reduction in both the memory consumption and the computation complexity required for the artificial neural network, which will also be referred to simply as a neural network, making it possible to improve the inference speed of the neural network.

Such typical quantization for a neural network determines a target quantization range for parameters related to a target layer of the neural network in accordance with statistical information on the parameters of only the target layer. The quantization range for parameters is defined such that extracted parameters within the quantization range are quantized. The typical quantization may result in large quantization error.

In view of the circumstances set forth above, an exemplary aspect of the present disclosure seeks to provide methods, apparatuses, and program products for quantization of a neural network, each of which is capable of offering quantization of a neural network with smaller quantization error.

A first measure of the present disclosure is a method of quantizing a neural network that includes sequential layers. Each of the sequential layers has weights and is configured to output, using the weights, features to a subsequent one of the sequential layers or another device. The sequential layers include a quantization target layer and a reference layer other than the quantization target layer. The method includes

1. Retrieving, from the reference layer, statistical information on layer parameters related to the reference layer, the layer parameters including the features of the reference layer

2. Determining, based on the statistical information, a quantization range for the layer parameters related to the quantization target layer

3. Quantizing selected layer parameters in the layer parameters related to the quantization target layer, the selected layer parameters being within the quantization range

A second measure of the present disclosure is an apparatus for quantizing a neural network that includes sequential layers. Each of the sequential layers has weights and is configured to output, using the weights, features to a subsequent one of the sequential layers or another device. The sequential layers include a quantization target layer and a reference layer other than the quantization target layer. The apparatus includes a retriever configured to retrieve, from the reference layer, statistical information on layer parameters related to the reference layer. The layer parameters include the features of the reference layer. The apparatus includes a determiner configured to determine, based on the statistical information, a quantization range for the layer parameters related to the quantization target layer. The apparatus includes a quantizer configured to quantize selected layer parameters in the layer parameters related to the quantization target layer. The selected layer parameters are within the quantization range.

A third measure of the present disclosure is a program product for a at least one processor for quantizing a neural network that includes sequential layers. Each of the sequential layers has weights and is configured to output, using the weights, features to a subsequent one of the sequential layers or another device. The sequential layers include a quantization target layer and a reference layer other than the quantization target layer. The program product includes a non-transitory computer-readable medium, and a set of computer program instructions embedded in the computer-readable medium. The instructions cause the at least one processor to

1. Retrieve, from the reference layer, statistical information on layer parameters related to the reference layer, the layer parameters including the features of the reference layer

2. Determine, based on the statistical information, a quantization range for the layer parameters related to the quantization target layer

3. Quantize selected layer parameters in the layer parameters related to the quantization target layer, the selected layer parameters being within the quantization range

Each of the first to third measures of the present disclosure makes it possible to reduce a quantization error due to quantization of layer parameters related to the quantization target layer.

The following describes embodiments of the present disclosure with reference to the accompanying drawings. In the embodiments, like parts between the embodiments, to which like reference characters are assigned, are omitted or simplified in description to avoid redundant description.

### First Embodiment

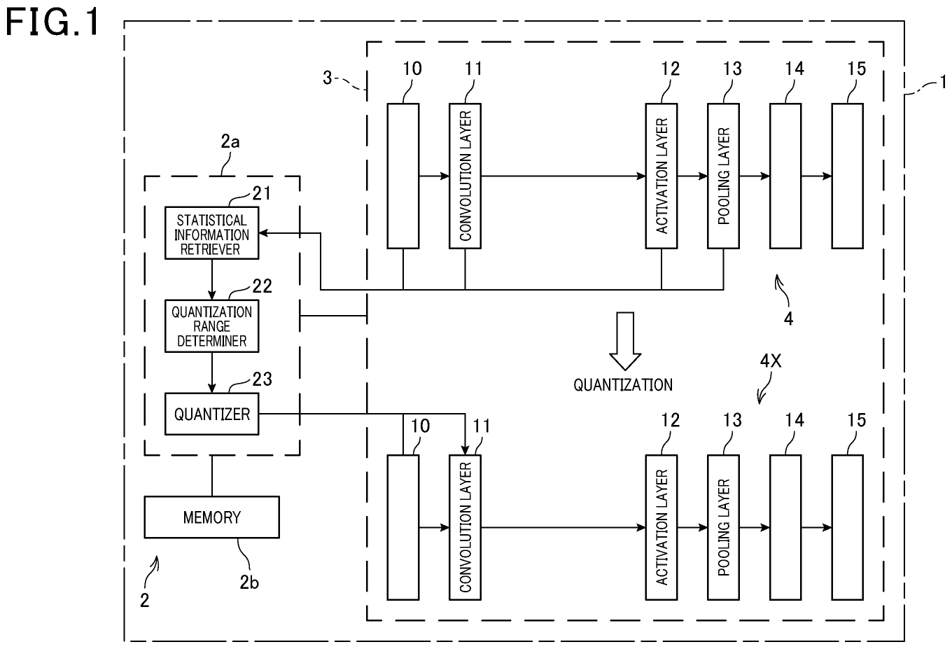

The following describes the first embodiment of the present disclosure with reference to FIGS. 1 to 3.

FIG. 1 schematically illustrates a neural-network apparatus 1 comprised of a quantization apparatus 2 and a CNN apparatus 3. The quantization apparatus 2 is configured to quantize a convolutional neural network (CNN) 4 implemented in the CNN apparatus 3; the CNN 4 is selected from various types of artificial neural networks according to the first embodiment.

As illustrated in FIG. 1, the quantization apparatus 2 includes at least one processor 2a and a memory 2b communicably connected to the processor 2a. For example, the quantization apparatus 2 is designed as at least one of various types of computers, various types of integrated circuits, or various types of hardware/software hybrid circuits. The memory 2b includes at least one of various types of storage media, such as ROMs, RAMs, flash memories, semiconductor memories, magnetic storage devices, or other types of memories.

The CNN apparatus 3 is communicably connected to the quantization apparatus 2. For example, the CNN apparatus 3 is designed as at least one of various types of computers, various types of integrated circuits, or various types of hardware/software hybrid circuits, and at least one unillustrated memory, which is comprised of at least one of various types of storage media set forth above.

The CNN apparatus 3 has implemented, i.e., stored, the CNN 4 in the memory thereof, and is configured to perform various tasks based on the CNN 4.

The memory 2b of the quantization apparatus 2 may store the CNN 4.

For example, the CNN 4 is comprised of (i) sequential layers, which include an input layer 10, a convolution layer 11, an activation layer, i.e., an activation function layer, 12, a pooling layer 13, and a fully connected layer 14, and (ii) an output layer 15. Each layer included in the CNN 4 is comprised of plural nodes, i.e., artificial neurons. Each of the layers 11, 12, 13, 14, and 15 is located subsequent to an immediately preceding layer of the corresponding one of the layers 10, 11, 12, 13, and 14.

For example, we schematically describe how the CNN apparatus 3 performs an image recognition task based on the CNN 4.

First, target image data to be recognized by the CNN apparatus 3 is inputted to the convolution layer 11 via the input layer 10.

The convolution layer 11 is configured to perform convolution, i.e., multiply-accumulate (MAC) operations, for the input image data using at least one filter, i.e., at least one kernel, and weights, to thereby detect feature maps, each of which is comprised of features. Each of the weights and features denotes, for example, an N-bit floating-point value, and the bitwidth, in other words, the number of bits, of each of the features and weights is N of, for example, 32.

The activation layer 12 is configured to perform an activation task of applying an activation function, which will be described later, to the feature maps outputted from the convolution layer 11 using weights to thereby output activated feature maps, each of which is comprised of activated features.

The pooling layer 13 is configured to perform a pooling task for each activated feature map, which subsamples, from each unit (i.e., each window) of the corresponding activated feature map, an important feature to accordingly output a subsampled feature map for the corresponding activated feature map; the subsampled feature map of each subsampled feature map is comprised of the subsampled features of the corresponding respective units.

The CNN apparatus 3 can include plural sets of the convolution layer 11, activation layer 12, and pooling layer 13.

The fully connected layer 14 is configured to

1. Perform transformation of the subsampled features included in the subsampled feature maps outputted from the pooling layer 13 to thereby generate a single vector (layer) of data items

2. Perform multiply-accumulate operations that multiplies the data items by predetermined weights, and calculates the sum of the multiplied data items for each node of the output layer 15 to thereby output a data label for each node of the output layer 15

The output layer 15 is configured to receive the data label for each node to thereby output a recognition result of the input image data for the corresponding node.

The features and/or weights related to each of the layers 10 to 15 will be collectively referred to as layer parameters related to the corresponding one of the layers 10 to 15.

The processor 2a of the quantization apparatus 2 functionally includes, for example, a statistical information retriever 21, a quantization range determiner 22, and a quantizer 23.

The statistical information retriever 21 is configured to retrieve, from, for example, each of the convolution layer 11, activation layer 12, and pooling layer 13, a distribution range of the layer parameters (i.e., N-bit floating-point values) of the corresponding one of the layers 11, 12, and 13; the distribution range of the CNN parameters of each layer 11, 12, 13 is defined from a minimum value and a maximum value of a statistical distribution of the layer parameters related to the corresponding layer. The distribution range of the layer parameters related to each layer 11, 12, 13 represent statistical information on the corresponding layer.

For example, the statistical information retriever 21 retrieves, from each layer 11, 12, and 13, i.e., each reference layer 11, 12, and 13, the minimum and maximum values of a frequency distribution range of the layer parameters of the corresponding layer as statistical information on the corresponding layer.

The quantization range determiner 22 is configured to determine a quantization range for the layer parameters of the convolution layer 11, which is selected from the layers 11 to 13 as at least one quantization target layer, in accordance with the frequency distribution range of the layer parameters of each layer 11, 12, 13 such that at least part of the frequency distribution range of the layer parameters of the convolution layer 11 is excluded from the determined quantization range for the layer parameters of the convolution layer 11; the excluded part of the distribution range of the layer parameters of the convolution layer 11 matches a region lying outside the frequency distribution range of the layer parameters of each of the activation layer 12 and the pooling layer 13.

The quantizer 23 is configured to quantize each of selected layer parameters from all the layer parameters of the convolution layer 11, i.e., the at least one quantization target layer, to a corresponding one of lower bitwidth values; the selected layer parameters are included within the quantization range determined by the quantization range determiner 22.

If the number of bits of each of unquantized layer parameters is identical to the number of bits of a corresponding one of quantized layer parameters, a smaller quantization range for quantizing each of the unquantized layer parameters results in a smaller quantization interval between the corresponding one of the quantized layer parameters. This therefore results in a decrease in a quantization error between each quantized layer parameter and the corresponding unquantized CNN parameter.

That is, quantization of at least part of the frequency distribution range of the layer parameters of the convolution layer 11, which matches a region lying outside the frequency distribution range of the layer parameters of each of the activation layer 12 and the pooling layer 13, would result in an ineffective region in the frequency distribution range of the layer parameters of each of the activation layer 12 and the pooling layer 13.

From this viewpoint, the quantization range determiner 22 of the first embodiment is configured to determine the quantization range for the layer parameters of the convolution layer 11, i.e., a selected at least one quantization target layer, in accordance with the frequency distribution range of the layer parameters of each layer 11, 12, 13 such that at least part of the frequency distribution range of the layer parameters of the convolution layer 11 is excluded from the determined quantization range for the layer parameters of the convolution layer 11; the excluded part of the frequency distribution range of the layer parameters of the convolution layer 11 matches a region lying outside the frequency distribution range of the layer parameters of each of the activation layer 12 and the pooling layer 13.

This configuration makes it possible to

1. Prevent an ineffective region from being generated in the frequency distribution range of the layer parameters of each of the activation layer 12 and the pooling layer 13

2. Reduce the quantization range for the layer parameters of the convolution layer 11 to thereby make smaller a quantization interval between the quantized layer parameters

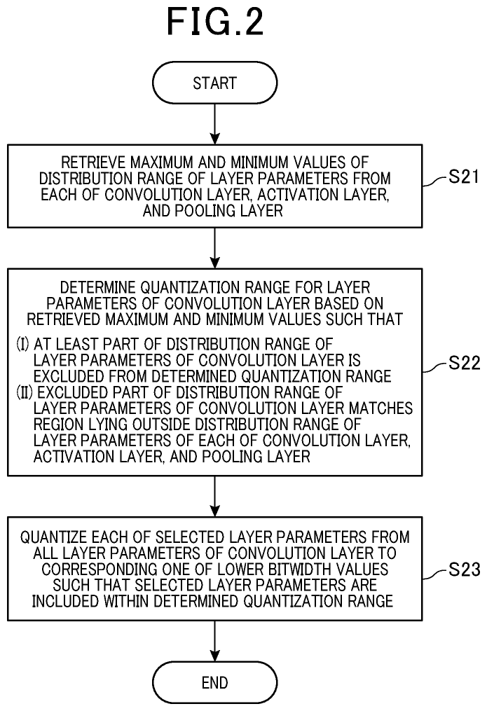

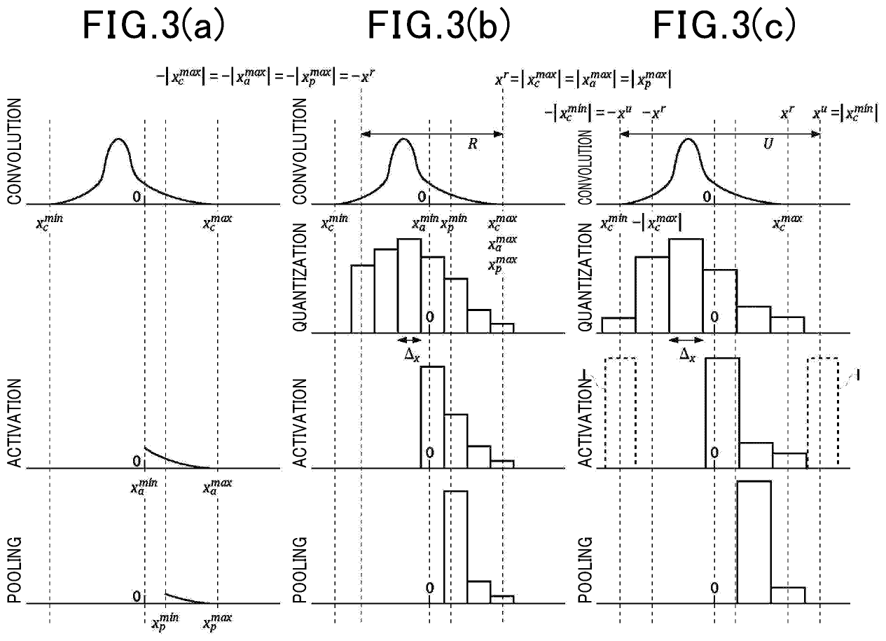

Next, the following describes, in detail, a CNN quantization method carried out by the quantization apparatus 2 with reference to FIGS. 2 and 3.

FIG. 2 is a flowchart schematically illustrating an example of the procedure of the CNN quantization method carried out by the processor 2a of the quantization apparatus 2 in accordance with instructions of a quantization program product presently stored in the memory 2b. That is, the quantization program product may be stored beforehand in the memory 2b or loaded from an external device to be presently stored therein.

In particular, the CNN quantization method according to the first embodiment uses, for example, symmetric quantization that quantizes unquantized layer parameters of at least one quantization target layer such that a zero point of the frequency distribution range of the unquantized layer parameters is symmetric with that of the frequency distribution range of quantized layer parameters.

When performing the CNN quantization method, the processor 2a serves as, for example, the statistical information retriever 21 to retrieve, from each of the convolution layer 11, activation layer 12, and pooling layer 13, the minimum and maximum values of the frequency distribution range of the layer parameters (i.e., N-bit floating-point values) of the corresponding one of the layers 11, 12, and 13 in step S21 of FIG. 2.

As illustrated in FIG. 3(a) and described above, the convolution layer 11 of the CNN 4 performs convolution for the input image data, the activation layer 12 applies the activation function to the feature maps outputted from the convolution layer 11, and the pooling layer 13 performs the pooling task that subsamples important features from each of the activated feature maps outputted from the activation layer 12.

The activation layer 12 according to the first embodiment is for example designed as a rectified linear unit (ReLU) that uses an ReLU activation function as the activation function; the ReLU activation function. The ReLU activation function returns zero when an input value is less than zero or returns the input value itself when the input value is above or equal to zero.

The pooling layer 13 performs, as an example of the pooling task for each activated feature map, max pooling that subsamples, from each of the units of the corresponding activated feature map, a maximum value as an important feature to accordingly output a subsampled feature map for the corresponding activated feature map; the subsampled feature map of each subsampled feature map is comprised of the subsampled maximum values of the corresponding respective units.

The maximum and minimum values of the frequency distribution range of the layer parameters of the convolution layer 11 will be respectively expressed by symbols X_{c}^{max} and X_{c}^{min}.

Similarly, the maximum and minimum values of the frequency distribution range of the layer parameters of the activation layer 12 will be respectively expressed by symbols Xₐ^{max} and Xₐ^{min}, and the maximum and minimum values of the frequency distribution range of the layer parameters of the pooling layer 13 will be respectively expressed by symbols Xₚ^{max} and Xₚ^{min}.

Next, the processor 2a serves as, for example, the quantization range determiner 22 to determine the quantization range for the layer parameters of the convolution layer 11 in accordance with the retrieved maximum and minimum values from each of the layers 11, 12, and 13 such that at least part of the frequency distribution range of the layer parameters of the convolution layer 11 is excluded from the determined quantization range for the layer parameters of the convolution layer 11 in step S22 of FIG. 2; the excluded part of the frequency distribution range of the layer parameters of the convolution layer 11 matches a region lying outside the frequency distribution range of the layer parameters of each of the activation layer 12 and the pooling layer 13.

Specifically, the quantization range determiner 22 retrieves, from the maximum values X_{c}^{max}, Xₐ^{max}, and Xₚ^{max} of the respective layers 11, 12, and 13, the minimum one of the maximum values X_{c}^{max}, Xₐ^{max}, and Xₚ^{max} in accordance with the following expression (1-1):

Xₘᵢₙ^{max}:min(X_{c}^{max},Xₐ^{max},Xₚ^{max}) (1-1)

where:

Xₘᵢₙ^{max} represents the minimum one of the maximum values Xc^{max}, Xa^{max}, and Xp^{max}, and

min (Xc^{max}, Xa^{max}, Xp^{max}) represents a function of outputting the minimum one of the maximum values X_{c}^{max}, Xₐ^{max}, and Xₚ^{max}.

The quantization range determiner 22 retrieves, from the minimum values X_{c}^{min}, Xₐ^{min}, and Xₚ^{min} of the respective layers 11, 12, and 13, the maximum one of the minimum values X_{c}^{min}, Xₐ^{min}, and Xₚ^{min} in accordance with the following expression (1-2):

Xₘₐₓ^{min}=max(X_{c}^{min},Xₐ^{min},Xₚ^{min}) (1-2)

where:

Xₘₐₓ^{min} represents the maximum one of the minimum values X_{c}^{min}, Xₐ^{min}, and Xₚ^{min}, and

max (X_{c}^{min}, Xₐ^{min}, Xₚ^{min}) represents a function of outputting the maximum one of the minimum values X_{c}^{min}, Xₐ^{min}, and Xₚ^{min}.

Then, the quantization range determiner 22 selects the maximum one of an absolute value |Xₘᵢₙ^{max}| of the value Xₘᵢₙ^{max} and an absolute value |Xₘₐₓ^{min}| of the value Xₘₐₓ^{min} in accordance with the following expression (1-3):

X^{r}=max(|Xₘᵢₙ^{max}|,|Xₘₐₓ^{min}|) (1-3)

where X^{r} represents the maximum one of the absolute value |Xₘᵢₙ^{max}| of the value Xₘᵢₙ^{max} and the absolute value |Xₘₐₓ^{min}| of the value Xₘᵢₙ^{max}.

Next, the quantization range determiner 22 determines the maximum value X^{r} as a quantization threshold for the quantization range for the layer parameters of the convolution layer 11, and determines the quantization range for the layer parameters of the convolution layer 11 in accordance with the following expression (1-4):

−X^{r}≤R≤X^{r} (1-4)

where R represents the quantization range for the layer parameters of the convolution layer 11.

For example, FIGS. 3(a) to 3(c) show that the maximum values X_{c}^{max}, Xₐ^{max}, and Xₚ^{max}, each of which is larger than 0 (>0), of the respective layers 11, 12, and 13 are the same as each other as represented by the following expression X_{c}^{max}=Xₐ^{max}=Xₚ^{max}.

This results in the minimum one Xₘᵢₙ^{max} of the maximum values X_{c}^{max}, Xₐ^{max}, and Xₚ^{max} being the same value X_{c}^{max}=Xₐ^{max}=Xₚ^{max}.

Additionally, FIGS. 3(a) to 3(c) show that the maximum one Xₘᵢₙ^{max} of the minimum value X_{c}^{min} (<0), the minimum value Xₐ^{min} (=0), and the minimum value Xₚ^{min} (>0), is the minimum value Xₚ^{m} n of the pooling layer 13. This can be represented by the following expression Xₘᵢₙ^{max}=Xₚ^{min}.

FIGS. 3(a) to 3(c) show that the absolute value |Xₘᵢₙ^{max}| of the minimum one Xₘᵢₙ^{max} of the maximum values X_{c}^{max}, Xₐ^{max}, and Xₚ^{max}, which is equal to each of the absolute values |X_{c}^{max}|, |Xₐ^{max}|, and |Xₚ^{max}|, is larger than the absolute value |Xₘᵢₙ^{max}| of the maximum one of the minimum values X_{c}^{min}, Xₐ^{min}, and Xₚ^{min}, which is equal to the absolute value |Xₚ^{min}| of the minimum value Xₚ^{min} of the pooling layer 13. This can be represented by the following expression |X_{c}^{max}|=|Xₐ^{max}|==|Xₚ^{max}|>|Xₚ^{min}|.

For this reason, the quantization threshold X^{r} of the quantization range for the layer parameters of the convolution layer 11 is determined by the absolute value |X_{c}^{max}| equal to each of the absolute value |Xₐ^{max}| and the absolute value |Xₚ^{max}|.

This makes it possible to exclude, from the frequency distribution range of the layer parameters of the convolution layer 11, a first part and a second part of the frequency distribution range of the layer parameters of the convolution layer 11; each of the first and second parts are defined as follows:

The first part of the frequency distribution range of the layer parameters of the convolution layer 11 is larger than the positive quantization threshold, i.e., +X^{r}, which is equal to each of the positive absolute values |X_{c}^{max}|, |Xₐ^{max}|, and |Xₚ^{max}|.

The second part of the frequency distribution range of the layer parameters of the convolution layer 11 is smaller than the negative quantization threshold, i.e., −X^{r}, which is smaller than the negative quantization threshold, i.e., −X^{r}, which is equal to each of the negative absolute values −|X_{c}^{max}|, −|Xₐ^{max}|, and −|Xₚ^{max}|.

Next, the processor 2a serves as, for example, the quantizer 23 to quantize each of selected layer parameters from all the layer parameters of the convolution layer 11 to a corresponding one of lower bitwidth values in step S23 of FIG. 2; the selected layer parameters are included within the quantization range determined by the operation in step S22. This results in a quantized CNN 4X being generated (see FIG. 1).

Specifically, the first embodiment results in each of the selected layer parameters, which is an N-bit floating-point value, of the convolution layer 11 being quantized to a corresponding one of lower bitwidth values, i.e., L-bit integer values, using the symmetric quantization in accordance with the following expression (2); the number N is for example 32, and the number L is for example 8:

x_{f}→Δₓx_{q} (2)

where:

x_{f} represents an original floating-point value (layer parameter) of the convolution layer 11,

Δx represents the quantization interval,

x_{q} represents a corresponding quantized integer, and

the symbol “→” represents mapping of the left-side value to the right-side value.

Specifically, the quantization-range determination step S22 determines the quantization range for the layer parameters of the convolution layer 11 in accordance with the retrieved maximum and minimum values from each of the layers 11, 12, and 13 such that at least part of the frequency distribution range of the layer parameters of the convolution layer 11 is excluded from the determined quantization range for the layer parameters of the convolution layer 11; the excluded part of the frequency distribution range of the layer parameters of the convolution layer 11 matches a region lying outside the frequency distribution range of the layer parameters of each of the activation layer 12 and the pooling layer 13.

This avoids the occurrence of an ineffective region in the frequency distribution range of the layer parameters of each of the activation layer 12 and the pooling layer 13, and reduces the quantization range for the layer parameters of the convolution layer 11 to thereby make smaller the quantization interval between the quantized layer parameters.

As illustrated in FIG. 3(b), the quantization range according to the first embodiment, which is assigned with the symbol R, for the layer parameters of the convolution layer 11 becomes smaller such that the absolute value of the original lower limit −X_{c}^{min} of the original quantization range for the layer parameters of the convolution layer 11 is reduced down to the absolute value of the lower limit −X^{r} of the quantization range R according to the first embodiment; the lower limit −X^{r} is equal to each of the negative absolute values −|X_{c}^{max}|, −|Xₐ^{max}|, and −|Xₚ^{max}|. This therefore makes smaller the quantization interval Δₓ between the quantized layer parameters according to the first embodiment.

For the sake of comparison with the first embodiment, the following describes a first comparative CNN quantization method for the CNN 4 carried out by a conventional quantization apparatus with reference to FIG. 3(c). To sum up, the first comparative CNN quantization method performs asymmetric quantization and determines the quantization range for the CNN 4 in accordance with only the statistical information on the convolution layer 11.

The first comparative CNN quantization method retrieves, from the convolution layer 11, only the maximum and minimum values X_{c}^{max} and X_{c}^{min} of the frequency distribution range of the layer parameters of the convolution layer 11 as the statistical information on the convolution layer 11.

Then, the first comparative CNN quantization method selects the maximum one of an absolute value |X_{c}^{max}| of the value X_{c}^{max} and an absolute value |X_{c}^{min}| of the value X_{c}^{min} in accordance with the following expression (3-1):

X^{u}=max(|X_{c}^{max}|,|X_{c}^{min}|) (3-1)

where X^{u} represents the maximum one of the absolute value |X_{c}^{max}| of the value X_{c}^{max} and the absolute value |X_{c}^{min}| of the value X_{c}^{min}.

Next, the first comparative CNN quantization method determines the maximum value X^{u} as the quantization threshold for the quantization range for the layer parameters of the convolution layer 11, and determines the quantization range for the layer parameters of the convolution layer 11 in accordance with the following expression (3-2):

−X^{u}≤U≤X^{u} (3-2)

where U represents the quantization range for the layer parameters of the convolution layer 11 according to the first comparative CNN quantization method.

As illustrated in FIG. 3(c), the first comparative CNN quantization method results in the absolute value |X_{c}^{max}| (>0) of the value X_{c}^{max} being smaller than the absolute value |X_{c}^{min}| of the value X_{c}^{min} (<0), which is represented by the following expression |X_{c}^{min}|>|X_{c}^{max}|. This results in the absolute value |X_{c}^{min}| of the value X_{c}^{min} of the frequency distribution range of the layer parameters of the convolution layer 11 being determined as the threshold quantization threshold X^{u} of the quantization range for the layer parameters of the convolution layer 11, which is represented by the following expression X^{u}=|X_{c}^{min}|.

That is, the quantization range U of the first comparative CNN quantization method, which is defined from the lower limit −X^{u}, i.e., |−X_{c}^{min}|, and the upper limit X^{u}, i.e., |X_{c}^{min}, may become larger than the quantization range R, which is defined from the lower limit −X^{r}, i.e., −|X_{c}^{max}|, to the upper limit +X^{r}, i.e., +|X_{c}^{max}|. This may therefore make larger the quantization interval Δₓ between the quantized layer parameters according to the first comparative CNN quantization method. This may result in ineffective regions I in the frequency distribution range of the layer parameters of the convolution layer 11, which does not occur in the first embodiment.

Each of the CNN quantization method and the quantization apparatus 2 according to the first embodiment achieves the following advantageous benefits.

Specifically, each of the CNN quantization method and the quantization apparatus 2 according to the first embodiment is characterized to

1. Retrieve, from each of the convolution layer 11, activation layer 12, and pooling layer 13, the minimum and maximum values of the frequency distribution range of the layer parameters (i.e., N-bit floating-point values) of the corresponding one of the layers 11, 12, and 13

2. Determine the quantization range for the layer parameters of the convolution layer 11 in accordance with the retrieved maximum and minimum values from each of the layers 11, 12, and 13 such that at least part of the frequency distribution range of the layer parameters of the convolution layer 11 is excluded from the determined quantization range for the layer parameters of the convolution layer 11; the excluded part of the frequency distribution range of the layer parameters of the convolution layer 11 matches a region lying outside the frequency distribution range of the layer parameters of each of the activation layer 12 and the pooling layer 13

Each of the CNN quantization method and the quantization apparatus 2 according to the first embodiment therefore prevents an ineffective region from being generated in the frequency distribution range of the layer parameters of each of the activation layer 12 and the pooling layer 13, and reduces the quantization range for the layer parameters of the convolution layer 11 to thereby reduce the quantization interval between the quantized layer parameters.

This therefore results in a decrease in a quantization error between each quantized layer parameter and the corresponding unquantized layer parameter.

The first embodiment uses each of the minimum and maximum values, i.e., the 0th percentile and the 100th percentile of the frequency distribution range of the layer parameters of each of the layers 11, 12, and 13, but the present disclosure is not limited thereto.

Specifically, the present disclosure can use a predetermined low percentile, which is substantially equivalent to the minimum value, such as the 3^{rd} percentile, of the frequency distribution range of the layer parameters as the minimum value thereof, and use a predetermined high percentile, which is substantially equivalent to the maximum value, such as the 97th percentile, of the frequency distribution range of the layer parameters as the maximum value thereof.

### Second Embodiment

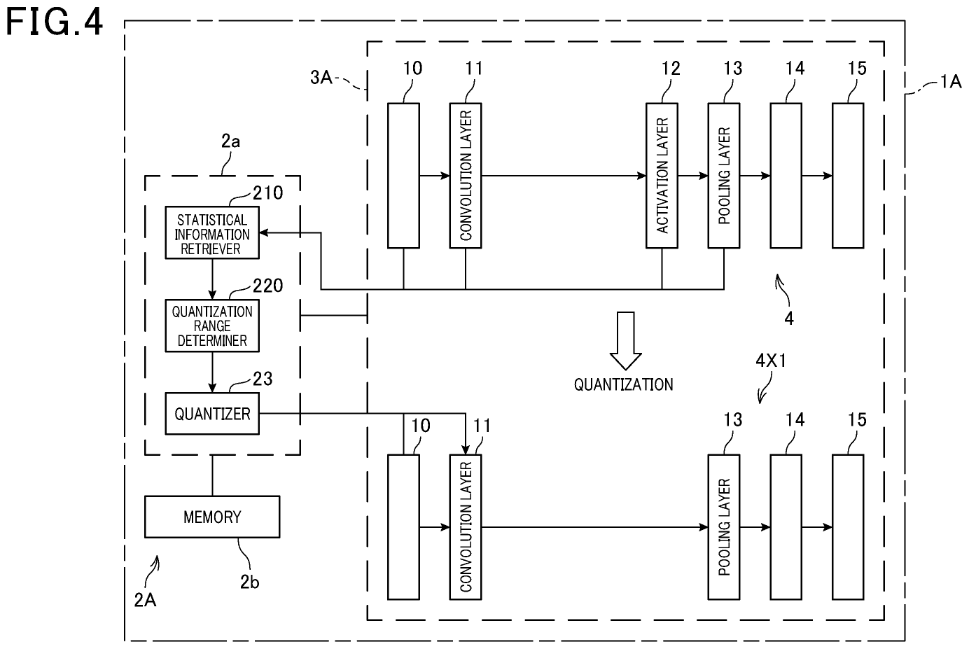

The following describes the second embodiment of the present disclosure with reference to FIGS. 4 to 6.

The following describes one or more points of the second embodiment, which are different from the configuration of the first embodiment.

There are components and operations, i.e., steps, in the second embodiment, which are identical to corresponding components and operations in the first embodiment. For the identical components and operations in the second embodiment, descriptions of the corresponding components and operations in the first embodiment are employed.

FIG. 4 schematically illustrates a neural-network apparatus 1A comprised of a quantization apparatus 2A and the CNN apparatus 3A according to the second embodiment.

The quantization apparatus 2A is configured to

1. Retrieve, from the activation layer 12, which is selected from the layers 11 to 13 as a reference layer, at least one saturation threshold indicative of at least one saturation region included in an input-output characteristic of the activation function as statistical information

2. Determine the quantization range for the layer parameters of the convolution layer 11 as at least one quantization target layer in accordance with the retrieved at least one saturation threshold such that at least part of the frequency distribution range of the layer parameters of the convolution layer 11 is excluded from the determined quantization range for the layer parameters of the convolution layer 11; the excluded part of the frequency distribution range of the layer parameters of the convolution layer 11 corresponds to the at least one saturation region of the activation function

Because the activation function has the at least one saturation region and a linear region, i.e., a non-saturation region, in its input-output characteristic, quantization of the layer parameters of the convolution layer 11 achieves the same result as that obtained by application of the activation function. This therefore makes it possible to eliminate the activation layer 12 from a CNN 4A or the activation task of applying the activation function to the feature maps outputted from the convolution layer 11.

The activation layer 12 of the CNN 4A implemented in the memory of the CNN apparatus 3A has the activation function that has, as the at least one saturation region, negative and positive saturation regions and a non-saturation region between the negative and positive saturation regions in its input-output characteristic.

Specifically, the activation function of the activation layer 12 is configured to return a constant output value when an input value lying within the negative or positive saturation region, and return an output value that is the same as an input value lying within the non-saturation region.

The processor 2a of the quantization apparatus 2A functionally includes, for example, a statistical information retriever 210, a quantization range determiner 220, and the quantizer 23; functions of the quantizer 23 according to the second embodiment are identical to those of the quantizer 23 according to the first embodiment.

The statistical information retriever 210 is configured to retrieve, from the activation layer 12 as the reference layer, (i) a negative saturation threshold indicative of the negative saturation region included in the input-output characteristic of the activation function, and (ii) a positive saturation threshold indicative of the positive saturation region included in the input-output characteristic of the activation function.

The quantization range determiner 220 is configured to determine the quantization range for the layer parameters of the convolution layer 11 as the at least one quantization target layer in accordance with the retrieved negative and positive thresholds such that first and second parts of the frequency distribution range of the layer parameters of the convolution layer 11 are excluded from the determined quantization range for the layer parameters of the convolution layer 11; each of the excluded first and second parts of the frequency distribution range of the layer parameters of the convolution layer 11 matches a corresponding one of the negative and positive saturation regions of the input-output characteristic of the activation function.

Quantization of each of first and second parts of the frequency distribution range of the layer parameters of the convolution layer 11, which matches a corresponding one of the negative and positive saturation regions of the activation region of the activation layer 12, would result in ineffective regions in the frequency distribution range of the layer parameters of the activation layer 12.

From this viewpoint, the quantization range determiner 220 of the second embodiment is configured to determine the quantization range for the layer parameters of the convolution layer 11 in accordance with the retrieved negative and positive thresholds such that the first and second parts of the frequency distribution range of the layer parameters of the convolution layer 11 are excluded from the determined quantization range for the layer parameters of the convolution layer 11; each of the excluded first and second parts of the frequency distribution range of the layer parameters of the convolution layer 11 matches a corresponding one of the negative and positive saturation regions of the input-output characteristic of the activation function.

This configuration makes it possible to

1. Prevent ineffective regions from being generated in the frequency distribution range of the layer parameters of the activation layer 12

2. Reduce the quantization range for the layer parameters of the convolution layer 11 to thereby make smaller a quantization interval between the quantized layer parameters

The activation function of the activation layer 12 has the negative and positive saturation regions and the non-saturation region in its input-output characteristic. The activation function returns a constant output value when an input value lying within the negative or positive saturation region, and return an output value that is the same as an input value lying within the non-saturation region.

For this reason, the quantization range determiner 220 is configured to determine the quantization range for the layer parameters of the convolution layer 11 such that the first and second parts of the frequency distribution range of the layer parameters of the convolution layer 11 are excluded from the determined quantization range for the layer parameters of the convolution layer 11; each of the excluded first and second parts of the frequency distribution range of the layer parameters of the convolution layer 11 matches a corresponding one of the negative and positive saturation regions of the input-output characteristic of the activation function.

This configuration therefore achieves the same result as that obtained by application of the activation function. This therefore makes it possible to eliminate the activation layer 12, which applies the activation function to the feature maps outputted from the convolution layer 11, from the CNN 4A.

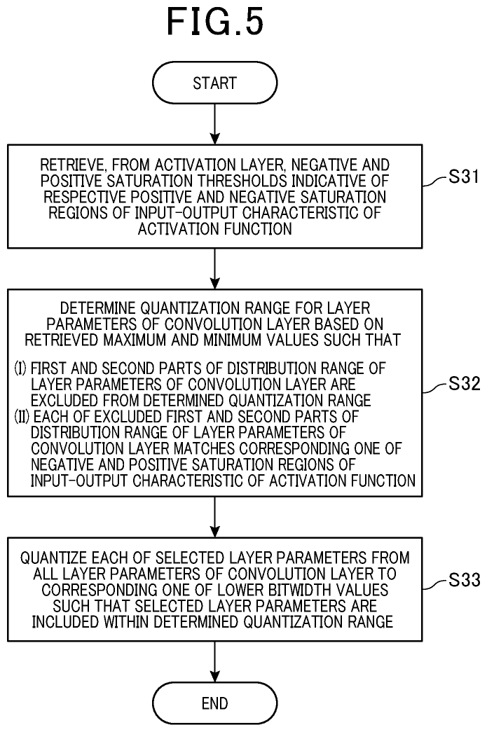

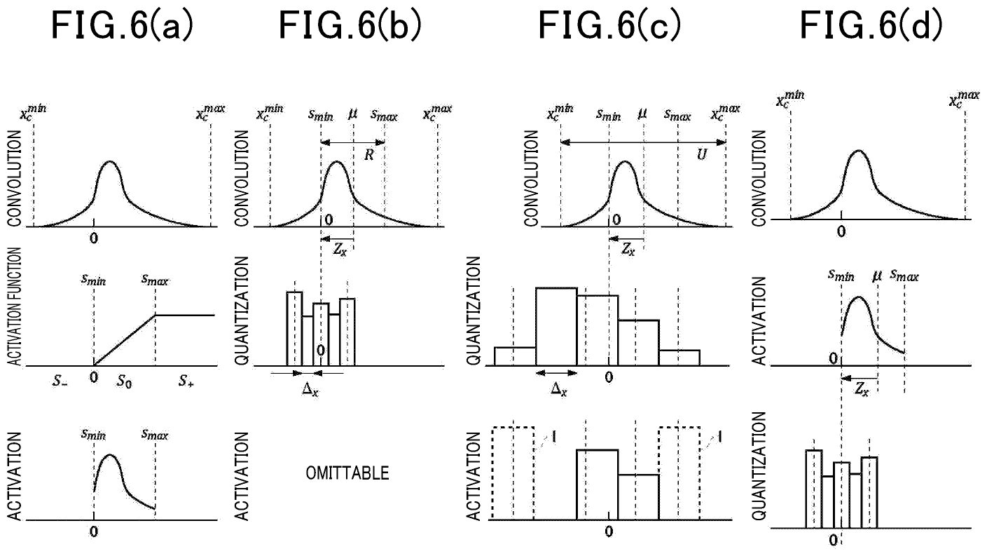

Next, the following describes, in detail, a CNN quantization method carried out by the quantization apparatus 2A of the second embodiment with reference to FIGS. 5 and 6.

FIG. 5 is a flowchart schematically illustrating an example of the procedure of the CNN quantization method carried out by the processor 2a of the quantization apparatus 2A of the second embodiment in accordance with instructions of a quantization program product presently stored in the memory 2b.

In particular, the CNN quantization method according to the second embodiment uses, for example, asymmetric quantization that quantizes unquantized layer parameters of at least one quantization target layer such that a zero point of the frequency distribution range of the unquantized layer parameters is shifted by a predetermined offset with respect to that of the frequency distribution range of quantized layer parameters.

As described above, referring to FIG. 6(a), the activation function of the activation layer 12 according to the second embodiment has the negative saturation region assigned with the symbol S₋, the positive saturation region assigned with the symbol S₊, and the non-saturation region assigned with the symbol S₀ in its input-output characteristic.

The activation function serves as a first function to return a constant output value when an input value lying within the negative saturation region 5_, and serves as a second function to return a constant output value when an input value lying within the positive saturation region S₊.

Additionally, the activation function serves as a linear function that returns an output value that is the same as an input value lying within the non-saturation region S₀.

As illustrated in FIG. 6(a), an upper limit of the negative saturation region S₋ is assigned with the symbol Sₘᵢₙ, and a lower limit of the positive saturation region S₊ is assigned with the symbol Sₘₐₓ.

When performing the CNN quantization method of the second embodiment, the processor 2a serves as, for example, the statistical information retriever 210 to retrieve, from the activation layer 12, (i) the upper limit Sₘᵢₙ of the negative saturation region S₋ as the negative saturation threshold indicative of the negative saturation region S₋, and (ii) the lower limit Sₘₐₓ of the positive saturation region S₊ as the positive saturation threshold indicative of the positive saturation region S₊ in step S31.

Next, the processor 2a serves as, for example, the quantization range determiner 220 to determine the quantization range for the layer parameters of the convolution layer 11 as the at least one quantization target layer in accordance with the retrieved upper limit Sₘᵢₙ of the negative saturation region S₋ and the retrieved lower limit Sₘₐₓ of the positive saturation region S₊ such that first and second parts of the frequency distribution range of the layer parameters of the convolution layer 11 are excluded from the determined quantization range for the layer parameters of the convolution layer 11 in step S32; each of the excluded first and second parts of the frequency distribution range of the layer parameters of the convolution layer 11 matches a corresponding one of the negative and positive saturation regions S₋ and S₊ of the input-output characteristic of the activation function.

In particular, as illustrated in FIG. 6(b), the quantization range determiner 220 determines the quantization range R for the layer parameters of the convolution layer 11, which is larger than the upper limit Sₘᵢₙ of the negative saturation region S₋ and smaller than the lower limit Sₘₐₓ of the positive saturation region S₊, in accordance with the following expression (4):

Sₘᵢₙ≤R≤Sₘₐₓ (4)

This results in a majority part of the negative saturation region S₋, which is smaller than the upper limit Sₘᵢₙ of the negative saturation region S₋, and a majority part of the positive saturation region S₊, which is larger than the negative lower limit Sₘₐₓ of the positive saturation region S₊, of the activation function being excluded from the quantization range R for the layer parameters of the convolution layer 11.

Next, the processor 2a serves as, for example, the quantizer 23 to quantize each of selected layer parameters from all the layer parameters of the convolution layer 11 to a corresponding one of lower bitwidth values in step S33 of FIG. 5; the selected layer parameters are included within the quantization range determined by the operation in step S32. This results in a quantized CNN 4Y being generated (see FIG. 4).

Specifically, the quantization-range determination step S32 determine the quantization range for the layer parameters of the convolution layer 11 in accordance with the retrieved upper limit Sₘᵢₙ of the negative saturation region S₋ and the retrieved lower limit Sₘₐₓ of the positive saturation region S₊ such that the first and second parts of the frequency distribution range of the layer parameters of the convolution layer 11 are excluded from the determined quantization range for the layer parameters of the convolution layer 11; each of the excluded first and second parts of the frequency distribution range of the layer parameters of the convolution layer 11 matches a corresponding one of the negative and positive saturation regions S₋ and S₊ of the input-output characteristic of the activation function.

This determination of the quantization range for the layer parameters of the convolution layer 11 avoids the occurrence of ineffective regions in the frequency distribution range of the layer parameters of the activation layer 12, and reduces the quantization range for the layer parameters of the convolution layer 11 to thereby make smaller the quantization interval between the quantized layer parameters.

Specifically, the second embodiment results in, as illustrated in FIG. 6(b), each of the selected layer parameters, which is an N-bit floating-point value, of the convolution layer 11 being quantized to a corresponding one of lower bitwidth values, i.e., L-bit integer values, using the symmetric quantization in accordance with the following expression (5); the number N is for example 32, and the number L is for example 8:

x_{f}→Δₓ(x_{q}−Zₓ) (5)

where Zₓ represents the offset.

As illustrated in FIG. 6(b), the original quantization range R, which is defined between the original upper and lower limits X_{c}^{max} and X_{c}^{min} inclusive, for the layer parameters of the convolution layer 11 is reduced down to the second-embodiment's quantization range R, which is defined between the upper limit Sₘᵢₙ of the negative saturation region S₋ and the lower limit Sₘₐₓ of the positive saturation region Sₘₐₓ. This therefore makes smaller the quantization interval Δₓ between the quantized layer parameters according to the second embodiment.

For the sake of comparison with the second embodiment, the following describes a second comparative CNN quantization method for the CNN 4 carried out by a conventional quantization apparatus with reference to FIG. 6(c). To sum up, the second comparative CNN quantization method performs symmetric quantization and determines the quantization range for the CNN 4 in accordance with only the statistical information on the convolution layer 11.

The second comparative CNN quantization method retrieves, from the convolution layer 11, only the maximum and minimum values X_{c}^{max} and X_{c}^{min} of the frequency distribution range of the layer parameters of the convolution layer 11 as the statistical information on the convolution layer 11.

Then, the second comparative CNN quantization method determines the quantization range U for the layer parameters of the convolution layer 11 in accordance with the following expression (6):

X_{c}^{min}≤U≤X_{c}^{max} (6)

That is, the quantization range U of the second comparative CNN quantization method, which is defined from the lower limit X_{c}^{min} and the upper limit X_{c}^{max} may become larger than the quantization range R, which is defined from the upper limit Sₘᵢₙ of the negative saturation region S₋ and the lower limit Sₘₐₓ of the positive saturation region Sₘₐₓ. This may therefore make larger the quantization interval Δₓ between the quantized layer parameters according to the second comparative CNN quantization method. This may result in ineffective regions I in the frequency distribution range of the layer parameters of the convolution layer 11, which has not occurred in the second embodiment.

As illustrated in FIG. 6(a), the activation function of the activation layer 12 according to the second embodiment has the negative saturation region S₋, the positive saturation region S₊, and the non-saturation region S₀ in its input-output characteristic. The first function of the activation function returns a constant output value when an input value lies within the negative saturation region S₋, and the second function of the activation function returns a constant output value when an input value lies within the positive saturation region S₊.

Additionally, the linear function of the activation function returns an output value that is the same as an input value lying within the non-saturation region S₀.

From this viewpoint, the quantization range determiner 220 employs the above features of the activation function. Specifically, the quantization range determiner 220 is configured to determine the quantization range for the layer parameters of the convolution layer 11 such that the first and second parts of the frequency distribution range of the layer parameters of the convolution layer 11 are excluded from the determined quantization range for the layer parameters of the convolution layer 11; each of the excluded first and second parts of the frequency distribution range of the layer parameters of the convolution layer 11 matches a corresponding one of the negative and positive saturation regions of the input-output characteristic of the activation function.

This configuration therefore achieves the same result as that obtained by application of the activation function. This therefore makes it possible to eliminate the activation layer 12, which applies the activation function to the feature maps outputted from the convolution layer 11, from the CNN 4A, resulting in a simplified CNN 4X1 with no activation layer 12.

For the sake of comparison with the second embodiment, the following describes a comparative neural-network apparatus with reference to FIG. 6(d). Because the comparative neural-network apparatus sequentially performs, through the CNN 4A and the quantization apparatus 2B, convolution, application of the activation function, and quantization of layer parameters used in the CNN 4A, it is difficult to eliminate the application of the activation function from the comparative neural-network apparatus.

Note that the quantized layer parameters obtained by the quantization apparatus 2A according to the second embodiment are identical to quantized layer parameters obtained by the comparative neural-network apparatus.

Each of the CNN quantization method and the quantization apparatus 2A according to the second embodiment achieves the following advantageous benefits.

Specifically, each of the CNN quantization method and the quantization apparatus 2A is configured to

1. Retrieve, from the activation layer 12, (i) the negative saturation threshold indicative of the negative saturation region included in the input-output characteristic of the activation function, and (ii) the positive saturation threshold indicative of the positive saturation region included in the input-output characteristic of the activation function

2. Determine the quantization range for the layer parameters of the convolution layer 11 in accordance with the retrieved negative and positive thresholds such that first and second parts of the frequency distribution range of the layer parameters of the convolution layer 11 are excluded from the determined quantization range for the layer parameters of the convolution layer 11; each of the excluded first and second parts of the frequency distribution range of the layer parameters of the convolution layer 11 matches a corresponding one of the negative and positive saturation regions of the input-output characteristic of the activation function.

This therefore avoids the occurrence of ineffective regions in the frequency distribution range of the layer parameters of the activation layer 12, and reduces the quantization range for the layer parameters of the convolution layer 11 to thereby make smaller the quantization interval between the quantized layer parameters. This results in a decrease in a quantization error between each quantized layer parameter and the corresponding unquantized CNN parameter.

Additionally, because the activation function included in the activation layer 12 or used by the activation task has the negative and positive saturation regions and the linear region, i.e., the non-saturation region, in its input-output characteristic, quantization of the layer parameters of the convolution layer 11 achieves the same result as that obtained by application of the activation function. This therefore makes it possible to eliminate the activation layer 12 from the CNN 4A or the activation task.

### Third Embodiment

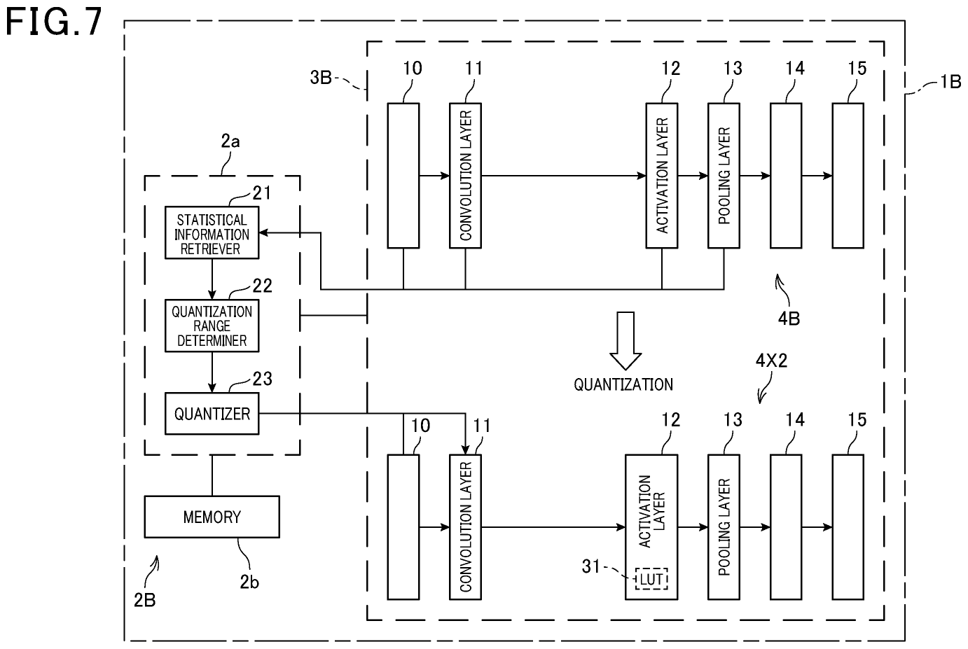

The following describes the third embodiment of the present disclosure with reference to FIGS. 7 to 9.

The following describes one or more points of the third embodiment, which are different from the configuration of the second embodiment.

There are components and operations, i.e., steps, in the third embodiment, which are identical to corresponding components and operations in the second embodiment. For the identical components and operations in the third embodiment, descriptions of the corresponding components and operations in the second embodiment are employed.

FIG. 7 schematically illustrates a neural-network apparatus 1B comprised of a quantization apparatus 2B and a CNN apparatus 3B according to the third embodiment.

The activation function used in the activation task has a non-saturation region S₀₁ in its input-output characteristic, and the activation function serves as a non-linear function that nonlinearly transforms an input value to an output value when the input value lies within the non-saturation region S₀₁.

Additionally, an activation layer 120 of a CNN 4B includes a lookup table (LUT) 31. The LUT 31 is designed as an M-bit LUT that serves as a function of applying the activation function to an M-bit input, and transforming, i.e., quantizing, the activated M-bit input to an L-bit integer value; the number M is, for example, 16 and the number L is for example 8.

Specifically, a quantizer 230 of the processor 2a of the quantization apparatus 2B is configured to quantize each of selected layer parameters, which is an N-bit floating-point value, of the convolution layer 11 within the quantization range R from the upper limit Sₘᵢₙ of the negative saturation region S₋ and the lower limit Sₘₐₓ of the positive saturation region Sₘₐₓ to a corresponding one of lower bitwidth values, i.e., M-bit floating-point values, using the symmetric quantization; the number N is for example 32.

The processor 2a causes the LUT 31 of the activation layer 12B to perform the activation task of applying the activation function to the quantized feature maps, i.e., the quantized layer parameters, outputted from the convolution layer 11 using weights to thereby output activated feature maps, each of which is comprised of activated features. As described above, the first function of the activation function returns a constant output value when an input value lying within the negative saturation region S₋, and the second function of the activation function returns a constant output value when an input value lying within the positive saturation region S₊.

Additionally, the non-linear function of the activation function nonlinearly transforms an input value to an output value when the input value lies within the non-saturation region S₀₁.

The processor 2a also causes the LUT 31 to perform unequal-interval quantization for each of the M-bit floating-point values to thereby output a corresponding one of lower bitwidth values, i.e., L-bit integer values.

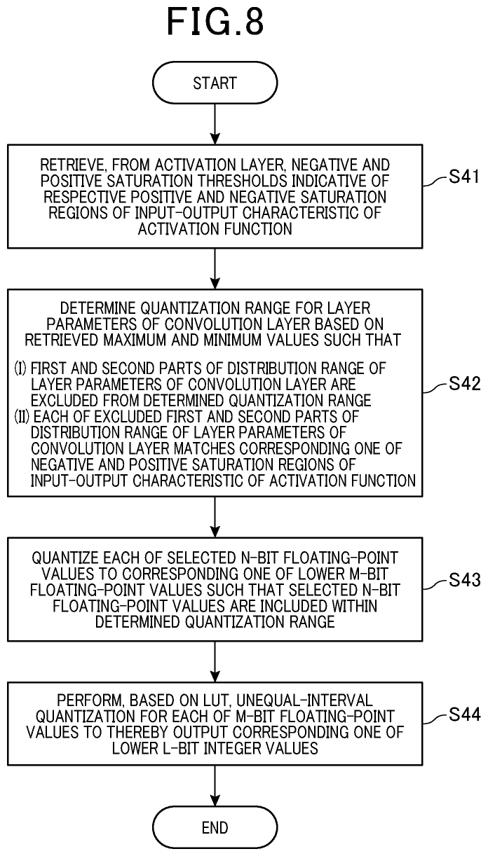

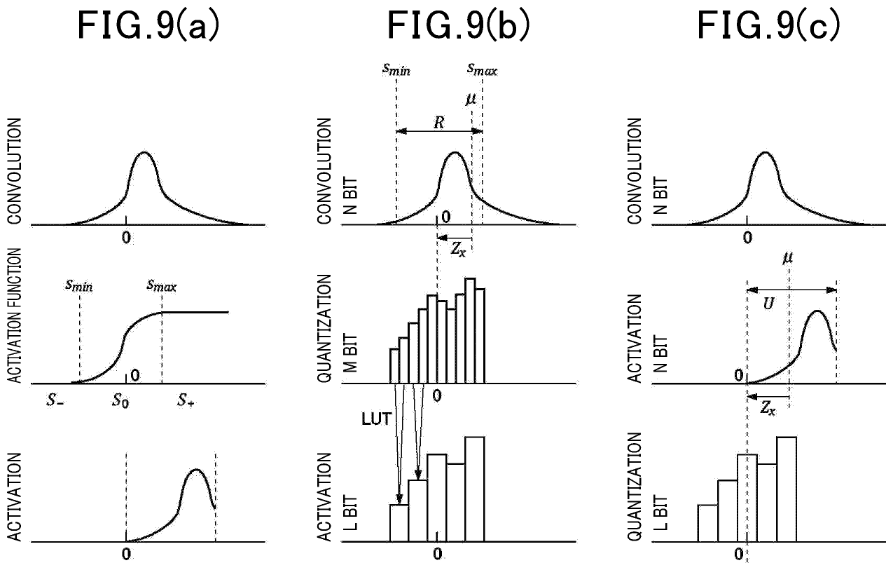

Next, the following describes, in detail, a CNN quantization method carried out by the quantization apparatus 2B of the third embodiment with reference to FIGS. 8 and 9.

FIG. 8 is a flowchart schematically illustrating an example of the procedure of the CNN quantization method carried out by the processor 2a of the quantization apparatus 2B of the third embodiment in accordance with instructions of a quantization program product presently stored in the memory 2b.

As described above, referring to FIG. 9(a), the activation function of the activation layer 12 according to the third embodiment has the negative saturation region S₋, the positive saturation region S₊, and the non-saturation region S₀₁ in its input-output characteristic.

The activation function serves as the first function to return a constant output value when an input value lying within the negative saturation region S₋, and serves as the second function to return a constant output value when an input value lying within the positive saturation region S₊.

Additionally, the activation function serves as the non-linear function that nonlinearly transforms an input value to an output value when the input value lies within the non-saturation region Sₒₗ.

When performing the CNN quantization method of the third embodiment, the processor 2a performs the operation in step S41, which is identical to the operation in step S31, and subsequently performs the operation in step S42, which is identical to the operation in step S32. Following the operation in step S42, the processor 2a serves as, for example, the quantizer 230 to quantize each of selected layer parameters, i.e., N-bit floating-point values, from all the layer parameters of the convolution layer 11 to a corresponding one of lower bitwidth values, i.e., M-bit floating-point values, in step S43 of FIG. 8; the selected layer parameters are included within the quantization range determined by the operation in step S42.

Next, the processor 2a performs, based on the LUT 31 of the activation layer 12B, the activation task of applying the activation function to the quantized feature maps, i.e., the quantized layer parameters, outputted from the convolution layer 11 using weights to thereby output activated feature maps, each of which is comprised of activated features in step S44.

Then, the processor 2a performs, based on the LUT 31 of the activation layer 12B, the unequal-interval quantization for each of the M-bit floating-point values to thereby output a corresponding one of lower bitwidth values, i.e., L-bit integer values in step S44.

This results in a quantized CNN 4X2 with the L-bit integer values being generated (see FIG. 7).

For the sake of comparison with the third embodiment, the following describes a comparative neural-network apparatus with reference to FIG. 9(d). The comparative neural-network apparatus sequentially performs, through the CNN 4B and the quantization apparatus 2B, convolution, application of the activation function, and quantization of rectifier parameters used in the CNN 4B. For this reason, the bitwidth of each value that is subjected to the activation task by the LUT 31 according to the comparative example is N that corresponds to the bitwidth of each bit outputted from the convolution layer 11; the N bitwidth is larger than the M bitwidth of the LUT 31.

Each of the CNN quantization method and the quantization apparatus 2B according to the third embodiment achieves the following advantageous benefits.

Specifically, the activation function according to the third embodiment has the non-saturation region S₀₁ in its input-output characteristic, and serves as a non-linear function that nonlinearly transforms an input value to an output value when the input value lies within the non-saturation region S₀₁.

Each of the CNN quantization method and the quantization apparatus 2B is configured to

1. Quantize each of N-bit floating-point values of the convolution layer 11 within the quantization range R from the lower limit Sₘᵢₙ to the upper limit Sₘₐₓ inclusive to a corresponding one of lower M-bit floating-point values

2. Cause the LUT 31 to perform the activation task of applying the activation function to the M-bit floating-point values outputted from the convolution layer 11

This enables the bitwidth of the LUT 31 to be smaller, making smaller the capacity of the memory of the CNN apparatus 3B, which stores the CNN 4B. This improves the hardware efficiency of the CNN apparatus 3B.

Each of the first to third embodiments is configured to select the convolution layer 11 as the at least one quantization target layer, but the present disclosure is not limited thereto. Specifically, each of the first to third embodiment may be configured to select one of the layers constituting the CNN 4B; the selected layer includes multiply-accumulate operations, such as the fully connected layer 14.

The first embodiment uses symmetric quantization to quantize the selected layer parameters, but may use asymmetric quantization to quantize the selected layer parameters, which is similar to the second or third embodiment.

### Fourth Embodiment

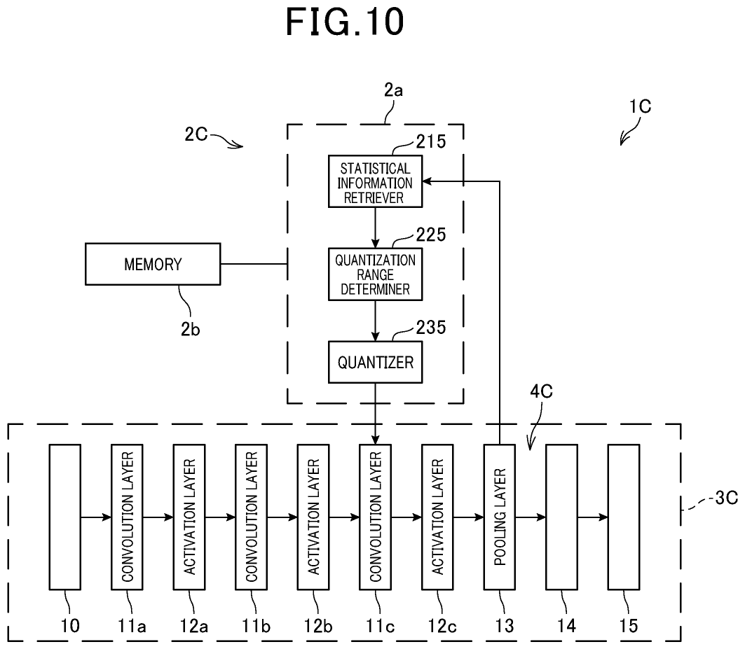

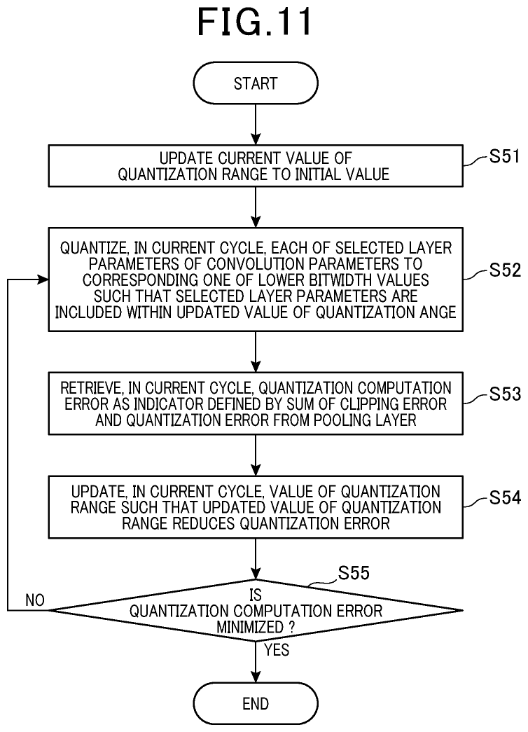

The following describes the fourth embodiment of the present disclosure with reference to FIGS. 10 and 11.

The following describes one or more points of the fourth embodiment, which are different from the configuration of the first embodiment.

There are components and operations, i.e., steps, in the fourth embodiment, which are identical to corresponding components and operations in the first embodiment. For the identical components and operations in the fourth embodiment, descriptions of the corresponding components and operations in the first embodiment are employed.

FIG. 10 schematically illustrates a neural-network apparatus 1C comprised of a quantization apparatus 2C and a CNN apparatus 3C according to the fourth embodiment.

As illustrated in FIG. 10, the CNN apparatus 3C has implemented, i.e., stored, the CNN 4C in the memory thereof, and is configured to perform various tasks based on the CNN 4C.

For example, the CNN 4C is comprised of the input layer 10, a first convolution layer 11a, a first activation layer 12a, a second convolution layer 11b, a second activation layer 12b, and a third convolution layer 11c, the pooling layer 13, the fully connected layer 14, and the output layer 15.

The first convolution layer 11a is configured to perform convolution, i.e., multiply-accumulate operations, for the input image data using at least one filter, i.e., at least one kernel, and weights, to thereby detect feature maps, each of which is comprised of features. Each of the weights and features denotes, for example, an N-bit floating-point value, and the bitwidth, in other words, the number of bits, of each of the features and weights is N of, for example, 32.

The first activation layer 12a is configured to perform an activation task of applying an activation function, which will be described later, to the feature maps outputted from the first convolution layer 11a using weights to thereby output activated feature maps, each of which is comprised of activated features.

The second convolution layer 11b is configured to perform the same operation as that of the first convolution layer 11a based on activated feature maps outputted from the first activation layer 12a.

The second activation layer 12b is configured to perform the same operation as that of the first activation layer 12a with respect to feature maps outputted from the second convolution layer 11b.

The third convolution layer 11c is configured to perform the same operation as that of the first convolution layer 11a based on activated feature maps outputted from the second activation layer 12b, thus outputting feature maps to the pooling layer 13.

The pooling layer 13 of the fourth embodiment is configured to perform the pooling task for each feature map outputted from the third convolution layer 11c in the same manner as the pooling layer 13 of the first embodiment.

The processor 2a of the quantization apparatus 2 functionally includes, for example, a statistical information retriever 215, a quantization range determiner 225, and a quantizer 235.

The module, i.e., the quantization module, of the statistical information retriever 215, the quantization range determiner 225, and the quantizer 235 is configured to periodically perform a quantization routine; one quantization routine periodically performed by the quantization module 215, 225, and 235 will be referred to as a cycle.

Specifically, the quantizer 235 is configured to perform a current cycle of the quantization routine that includes

(i) Quantization of each of selected layer parameters from all the layer parameters of the third convolution layer 11c, which is selected as at least one quantization target layer, to a corresponding one of lower bitwidth values; the selected layer parameters are included within an updated value of the quantization range determined at an immediately previous cycle of the quantization routine by the quantization range determiner 225

(ii) Determination of first and second clipping thresholds based on the quantization range

(iii) Execution of a clipping task using the first and second clip thresholds

The clipping task is designed to clip values, which will be referred to as deviation values, lying outside a range defined between the first and second clip thresholds from the quantized layer parameters, i.e., the quantized values, in accordance with the following expression (7) in order to prevent an increase in the quantization range due to the deviation values to thereby prevent an increase in a quantization error due to an increase in the quantization interval:

$$x = clipping ( x , {c}_{min} , {c}_{max} ) = \{ \begin{matrix}{c}_{min} & ( x > {c}_{min} ) \\ x & ( {c}_{min} < x < {c}_{max} \\ {c}_{max} & {c}_{max} < x\end{matrix} \} \qquad ( 7 )$$

where:

x represents each quantized value;

cₘᵢₙ represents the first clip threshold; and

cₘₐₓ represents the second clip threshold

Although the clipping task may result in a clipping error due to the clipped values from the quantized values, the clipping task makes smaller the quantization interval to thereby reduce the quantization error, making it possible to reduce a total quantization error defined by the sum of the clipping error and the quantization error.

The statistical information retriever 215 is configured to retrieve, in the current cycle of the quantization routine, the total quantization error defined by the sum of the clipping error and the quantization error from the pooling layer 13, which is selected as a reference layer.

The fourth embodiment uses, as an error parameter indicative of the quantization error, a means square error (MSE) between each unquantized value and the corresponding quantized value, a mean average error (MAE) between each unquantized value and the corresponding quantized value, or a K-L divergence therebetween.

The quantization range determiner 225 is configured to update, in the current cycle of the quantization routine, the value of the quantization range such that the updated value of the quantization range makes smaller the total quantization error, and pass the updated value of the quantization range to the quantizer 235 for the next cycle of the quantization routine.

That is, the cycles of the quantization routine periodically performed by the quantization module of the statistical information retriever 215, the quantization range determiner 225, and the quantizer 235 makes it possible to optimize the quantization range that enables the quantization error to be minimized.

An initial value of the quantization routine used by the quantizer 235, one of the quantization ranges determined by the respective first to third embodiments may be used.

FIG. 11 is a flowchart schematically illustrating an example of the procedure of the CNN quantization method carried out by the processor 2a of the quantization apparatus 2C of the fourth embodiment in accordance with instructions of a quantization program product presently stored in the memory 2b.

When performing the CNN quantization method of the fourth embodiment, the processor 2a serves as, for example, the quantization determiner 225 to perform an initialization task that updates a current value of the quantization range for the third convolution layer 11c to an initial value of the quantization routine; the initial value of the quantization routine matches one of the quantization ranges determined by the respective first to third embodiments in step S51 of FIG. 11

Next, the processor 2a serves as, for example, the quantization module 215, 225, and 235 to periodically perform the quantization routine.

Specifically, the quantizer 235 quantizes, in a current cycle of the quantization routine, each of selected layer parameters from all the layer parameters of the convolution layer 11 to a corresponding one of lower bitwidth values in step S52 of FIG. 11; the selected layer parameters are included within the quantization range determined by the operation in step S51.

In step S52, the quantizer 235 performs, in the current cycle of the quantization routine, the clipping task that clips deviation values lying outside the range defined between the first and second clip thresholds from the quantized layer parameters, i.e., the quantized values, in accordance with the above expression (7); the lower limit and the upper limit of the quantization range determined by the operation in step S51 are respectively used as the first and second clip thresholds.

Following the operation in step S52, the statistical information retriever 215 retrieves, in the current cycle of the quantization routine, the total quantization error defined by the sum of the clipping error and the quantization error from the pooling layer 13 in step S53.

Then, in step S54, the quantization range determiner 225 updates, in the current cycle of the quantization routine, the value of the quantization range such that the updated value of the quantization range makes smaller the total quantization error.

Next, the quantization range determiner 225 determines whether the total quantization error is minimized in step S55.

If it is determined that the total quantization error is not minimized (NO in step S55), the processor 2a returns to step S52, and performs the next cycle of the quantization routine from step S52 using the updated value of the quantization range obtained in step S54.

Otherwise, if it is determined that total quantization error is minimized at the current cycle or a future cycle of the quantization routine (YES in step S55), the processor 2a terminates the quantization routine to accordingly terminate the CNN quantization method.

Each of the CNN quantization method and the quantization apparatus 2C according to the fourth embodiment achieves the following advantageous benefits.

Each of the CNN quantization method and the quantization apparatus 2C performs

(i) Quantization of each of selected layer parameters from all the layer parameters of the third convolution layer 11c to a corresponding one of lower bitwidth values; the selected layer parameters are included within an updated value of the quantization range determined at an immediately previous cycle of the quantization routine by the quantization range determiner 225

(ii) Determination of first and second clipping thresholds based on the quantization range

(iii) Execution of a clipping task using the first and second clip thresholds

(iv) Retrieval of the total quantization error defined by the sum of the clipping error and the quantization error from the pooling layer 13

(v) Updating of the value of the quantization range such that the updated value of the quantization range makes smaller the total quantization error

(vi) Determination of whether the total quantization error is minimized

(vii) Repeat the operations (i) to (vi) until it is determined that the total quantization error is minimized

This enables the quantization range for the at least one quantization target layer 11c to be optimized, so that the total quantization error defined by the sum of the clipping error and the quantization error is minimized.

The fourth embodiment selects the third convolution layer as the at least one quantization target layer whose layer parameters are quantized and whose quantization range is optimized, but the present disclosure is not limited thereto.

Specifically, the present disclosure may be configured to select one or more layers from the layers 11a, 11b, 12a, 12b, and 11c as the at least one quantization target layer whose layer parameters are quantized and whose quantization range is optimized.

The fourth embodiment selects the pooling layer 13 as the reference layer, and uses the total quantization error defined by the sum of the clipping error and the quantization error as an indicator indicative of a level of optimization of the pooling layer 13, but the present disclosure may select another layer in the CNN 4C as the reference layer, and use another indicator indicative of the level of optimization of the reference layer.

Each of the first to fourth embodiments is configured such that each layer parameter is a N-bit floating-point value, but the present disclosure is not limited thereto. Specifically, each layer parameter is a floating-point value or an integer value with another bit.

As a modification of the fourth embodiment, the present disclosure selects the output layer 15 as the reference layer, and uses a recognition accuracy calculated based on application of a recognition-accuracy evaluation function to the recognition result for each node outputted from the output layer 15. This modification optimizes the quantization range for the at least one quantization target layer such that the recognition accuracy is maximized.

The functions of one element in each embodiment can be distributed as plural elements, and the functions that plural elements have can be combined into one element. The functions of respective elements in each embodiment can be implemented by a single element, and a single function implemented by plural elements in each embodiment can be implemented by a single element. At least part of the structure of each embodiment can be eliminated. At least part of each embodiment can be added to the structure of another embodiment, or can be replaced with a corresponding part of another embodiment.

The present disclosure can be implemented by various embodiments in addition to the first to fourth embodiments; the various embodiments include

1. Systems each include a quantization apparatus whose subject matter is identical to the subject matter of one of the quantization apparatuses 2 to 2C

2. Programs for causing a computer to perform functions installed in one of the quantization apparatuses 2 to 2C

3. Programs for causing a computer to perform all the steps of one of the CNN quantization methods according to the respective embodiments

4. Non-volatile storage media, such as semiconductor memories, each of which stores a corresponding one of the programs

While illustrative embodiments of the present disclosure have been described herein, the present disclosure is not limited to the embodiment described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. A method of quantizing a neural network that comprises sequential layers, each of the sequential layers having weights and being configured to output, using the weights, features to a subsequent one of the sequential layers or another device, the sequential layers including a quantization target layer and a reference layer other than the quantization target layer, the method comprising:
retrieving, from the reference layer, statistical information on layer parameters related to the reference layer, the layer parameters including the features of the reference layer;
determining, based on the statistical information, a quantization range for the layer parameters related to the quantization target layer; and
quantizing selected layer parameters in the layer parameters related to the quantization target layer, the selected layer parameters being within the quantization range.

2. The method according to claim 1, wherein:
the reference layer is subsequent to the quantization target layer;
the statistical information represents a distribution range of the layer parameters related to the reference layer;
the determining step determines the quantization range for the layer parameters related to the quantization target layer such that at least part of a distribution range of the layer parameters related to the quantization target layer is excluded from the quantization range for the layer parameters related to the quantization target layer, the excluded part of the distribution range of the layer parameters related to the quantization target layer matching a region lying outside the distribution range of the layer parameters related to the reference layer.

3. The method according to claim 1, wherein:
the reference layer is an activation layer located subsequent to the quantization target layer, the activation layer having an activation function, and being configured to apply the activation function to the layer parameters related to the target quantization layer;
the statistical information represents at least one saturation region included in an input-output characteristic of the activation function; and
the determining step determines the quantization range for the layer parameters related to the quantization target layer such that at least part of a distribution range of the layer parameters related to the quantization target layer is excluded from the quantization range for the layer parameters related to the quantization target layer, the excluded part of the distribution range of the layer parameters related to the quantization target layer matching a majority part of at least one saturation region of the activation function.

4. The method according to claim 3, wherein:
the activation function has a linear function that has at least one non-saturation region in the input-output characteristic thereof.

5. The method according to claim 3, wherein:
the activation function has a non-linear function that has at least one non-saturation region in the input-output characteristic thereof.

6. The method according to claim 1, wherein:
the reference layer is subsequent to the quantization target layer;
the statistical information represents an indicator indicative of a level of optimization of the reference layer; and
the determining step determines the quantization range for the layer parameters related to the quantization target layer to thereby maximize the indicator.

7. The method according to claim 1, wherein:
the quantizing step includes:
a step of determining first and second clip thresholds based on the quantization range; and
a step of clipping at least one of the quantized layer parameters, the at least one of the quantized layer parameters lying outside a range defined between the first and second clip thresholds; and
the indicator is an error due to at least one of the quantizing step and the clipping step.

8. The method according to claim 6, wherein:
the sequential layers include an output layer; and
the indicator is a recognition accuracy of the output layer.

9. The method according to claim 1, wherein:
the layer parameters include the weights of the reference layer.

10. An apparatus for a neural network that comprises sequential layers, each of the sequential layers having weights and being configured to output, using the weights, features to a subsequent one of the sequential layers or another device, the sequential layers including a quantization target layer and a reference layer other than the quantization target layer, the apparatus comprising:
a retriever configured to retrieve, from the reference layer, statistical information on layer parameters related to the reference layer, the layer parameters including the features of the reference layer;
a determiner configured to determine, based on the statistical information, a quantization range for the layer parameters related to the quantization target layer; and
a quantizer configured to quantize selected layer parameters in the layer parameters related to the quantization target layer, the selected layer parameters being within the quantization range.

11. The apparatus according to claim 10, wherein:
the reference layer is subsequent to the quantization target layer;
the statistical information represents a distribution range of the layer parameters related to the reference layer;
the determiner is configured to determine the quantization range for the layer parameters related to the quantization target layer such that at least part of a distribution range of the layer parameters related to the quantization target layer is excluded from the quantization range for the layer parameters related to the quantization target layer, the excluded part of the distribution range of the layer parameters related to the quantization target layer matching a region lying outside the distribution range of the layer parameters related to the reference layer.

12. The apparatus according to claim 10, wherein:
the reference layer is an activation layer located subsequent to the quantization target layer, the activation layer having an activation function, and being configured to apply the activation function to the layer parameters related to the target quantization layer;
the statistical information represents at least one saturation region of included in an input-output characteristic of the activation function; and
the determiner is configured to determine the quantization range for the layer parameters related to the quantization target layer such that at least part of a distribution range of the layer parameters related to the quantization target layer is excluded from the quantization range for the layer parameters related to the quantization target layer, the excluded part of the distribution range of the layer parameters related to the quantization target layer matching a majority part of at least one saturation region of the activation function.

13. The apparatus according to claim 12, wherein:
the activation function has a linear function that has at least one non-saturation region in the input-output characteristic thereof.

14. The apparatus according to claim 12, wherein:
the activation function has a non-linear function that has at least one non-saturation region in the input-output characteristic thereof.

15. The apparatus according to claim 10, wherein:
the reference layer is subsequent to the quantization target layer;
the statistical information represents an indicator indicative of a level of optimization of the reference layer; and
the determiner is configured to determine the quantization range for the layer parameters related to the quantization target layer to thereby maximize the indicator.

16. The apparatus according to claim 10, wherein:
the quantizer is configured to:
determine first and second clip thresholds based on the quantization range; and
clip at least one of the quantized layer parameters, the at least one of the quantized layer parameters lying outside a range defined between the first and second clip thresholds; and
the indicator is an error due to at least one of the quantizing step and the clipping step.

17. The apparatus according to claim 15, wherein:
the sequential layers include an output layer; and
the indicator is a recognition accuracy of the output layer.

18. The apparatus according to claim 10, wherein:
the layer parameters include the weights of the reference layer.

19. A program product for a at least one processor for quantizing a neural network that comprises sequential layers, each of the sequential layers having weights and being configured to output, using the weights, features to a subsequent one of the sequential layers or another device, the sequential layers including a quantization target layer and a reference layer other than the quantization target layer, the program product comprising:
a non-transitory computer-readable medium; and
a set of computer program instructions embedded in the computer-readable medium, the instructions causing the at least one processor to:
retrieve, from the reference layer, statistical information on layer parameters related to the reference layer, the layer parameters including the features of the reference layer;
determine, based on the statistical information, a quantization range for the layer parameters related to the quantization target layer; and
quantize selected layer parameters in the layer parameters related to the quantization target layer, the selected layer parameters being within the quantization range.
